(19) United States
(12) Patent Application Publication
(10) Pub. No.: US 2025/0232719 A1
(43) Pub. Date: Jul. 17, 2025

(54) LIGHT EMITTING DEVICE, DISPLAY DEVICE, PHOTOELECTRIC CONVERSION DEVICE, ELECTRONIC APPARATUS, ILLUMINATION DEVICE, AND MOVING BODY

(71) Applicant: CANON KABUSHIKI KAISHA, Tokyo (JP)

(72) Inventor: TARO MURAKI, Kanagawa (JP)

(21) Appl. No.: 19/001,763

(22) Filed: Dec. 26, 2024

(30) Foreign Application Priority Data
Jan. 11, 2024 (JP) 2024-002792

(51) Int. Cl. G09G 3/3225; F21S 43/145; F21Y 115/15; G03G 15/04; G09G 3/00; H04M 1/02; H04N 23/53

(52) U.S. Cl. CPC G09G 3/3225; F21S 43/145; F21Y 2115/15; G03G 15/04054; G09G 3/003; G09G 3/035; G09G 2300/0842; G09G 2300/0861; G09G 2310/08; G09G 2320/0233; G09G 2320/045; G09G 2380/10; H04M 1/0266; H04N 23/53

(57) ABSTRACT

A light emitting device is provided. The device includes: a plurality of pixels each including a light emitting element, and arranged in rows and columns; a driver configured to write signals having signal values corresponding to luminous brightness; and a signal processor. The signal processor selects pixels of a first group and pixels of a second group, signal values of the pixels in the first group exceeding a predetermined threshold out of the plurality of pixels, and signal values of the pixels in the second group being not more than the predetermined threshold out of the plurality of pixels, and the driver writes signals in the pixels included in the first group in a first period, and writes signals in the pixels included in the second group in a second period different from the first period.

### BACKGROUND OF THE INVENTION

### Field of the Invention

The present invention relates to a light emitting device, a display device, a photoelectric conversion device, an electronic apparatus, an illumination device, and a moving body.

### Description of the Related Art

Japanese Patent Laid-Open No. 2007-024994 describes a display device in which a light detection element is provided in the vicinity of each light emitting element arranged in a display surface to correct the brightness of the light emitting element while an image is being displayed.

### SUMMARY OF THE INVENTION

During the operation of a light emitting device, a current flowing through a power supply line common to a plurality of light emitting elements may fluctuate and the potential of the power supply line may temporarily fluctuate. If a brightness signal is written during the fluctuation of the potential of the power supply line, the signal written in the light emitting element can fluctuate due to the influence of the fluctuation of the potential of the power supply line, and uneven light emission or the like can occur. The operation described in Japanese Patent Laid-Open No. 2007-024994 may not be able to cope with the temporary fluctuation of the potential of the power supply line.

Some embodiments of the present disclosure provide a technique advantageous in suppressing uneven light emission.

According to some embodiments, a light emitting device comprising: a plurality of pixels each including a light emitting element, and arranged in rows and columns; a driving circuit configured to write signals having signal values corresponding to luminous brightness in the plurality of pixels; and a signal processing circuit, wherein the signal processing circuit is configured to select pixels of a first group and pixels of a second group, signal values of the pixels in the first group exceeding a predetermined threshold out of the plurality of pixels, and signal values of the pixels in the second group being not more than the predetermined threshold out of the plurality of pixels, and the driving circuit is configured to write signals in the pixels included in the first group in a first period, and write signals in the pixels included in the second group in a second period different from the first period, is provided.

Further features of the present invention will become apparent from the following description of exemplary embodiments (with reference to the attached drawings).

### BRIEF DESCRIPTION OF THE DRAWINGS

FIG. 1 is a block diagram showing an example of the arrangement of a light emitting device according to an embodiment;

FIG. 2 is a view showing an example of the arrangement of a pixel region and a driving circuit of the light emitting device shown in FIG. 1;

FIG. 3 is a view showing an example of the arrangement of a pixel of the light emitting device shown in FIG. 1;

FIG. 4 is a timing chart showing an operation example of the light emitting device shown in FIG. 1;

FIG. 5 is a timing chart showing an operation example of the light emitting device shown in FIG. 1;

FIG. 6 is a timing chart showing an operation example of the light emitting device shown in FIG. 1;

FIG. 7 is a timing chart showing an operation example of the light emitting device shown in FIG. 1;

FIGS. 8A and 8B are sectional views showing an example of the arrangement of the pixel of the light emitting device shown in FIG. 1;

FIGS. 9A to 9C are views showing an example of an image forming device using the light emitting device according to the embodiment;

FIG. 10 is a view showing an example of a display device using the light emitting device according to the embodiment;

FIG. 11 is a view showing an example of a photoelectric conversion device using the light emitting device according to the embodiment;

FIG. 12 is a view showing an example of an electronic apparatus using the light emitting device according to the embodiment;

FIGS. 13A and 13B are views each showing an example of a display device using the light emitting device according to the embodiment;

FIG. 14 is a view showing an example of an illumination device using the light emitting device according to the embodiment;

FIG. 15 is a view showing an example of a moving body using the light emitting device according to the embodiment; and

FIGS. 16A and 16B are views each showing an example of a wearable device using the light emitting device according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

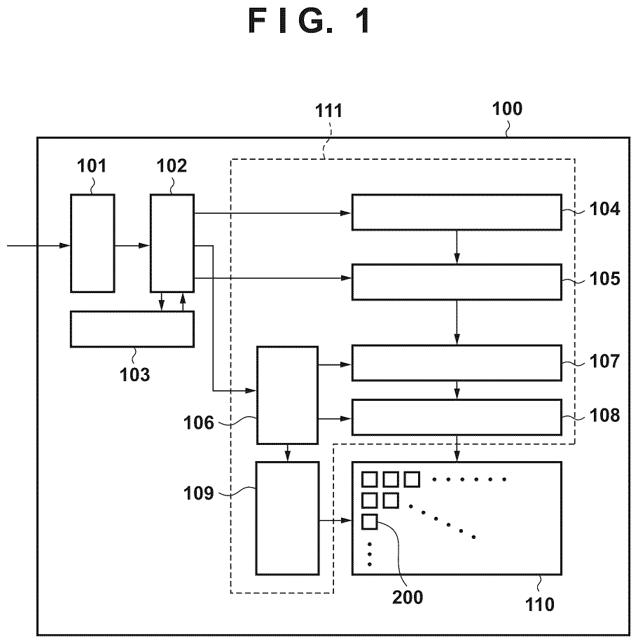

With reference to FIGS. 1 to 7, a light emitting device according to each embodiment of the present disclosure will be described. The embodiments to be explained below are merely examples of the present disclosure, and the numerical values, shapes, materials, the arrangement of the components, and the like do not intend to limit the present disclosure.

FIG. 1 is a block diagram showing an example of the arrangement of a light emitting device 100 according to the embodiment. The light emitting device 100 includes a plurality of pixels 200, a driving circuit 111 that writes a signal having a signal value corresponding to a luminous brightness in each of the plurality of pixels 200, and a signal processing circuit 102. As shown in FIG. 1, the driving circuit 111 can include a column selection circuit 104, a column memory 105, a timing signal generator 106, a column digital-analog converter (DAC) 107, a column buffer 108, and a row selection circuit 109. The light emitting device 100 can further include a receiving circuit 101 and a memory 103.

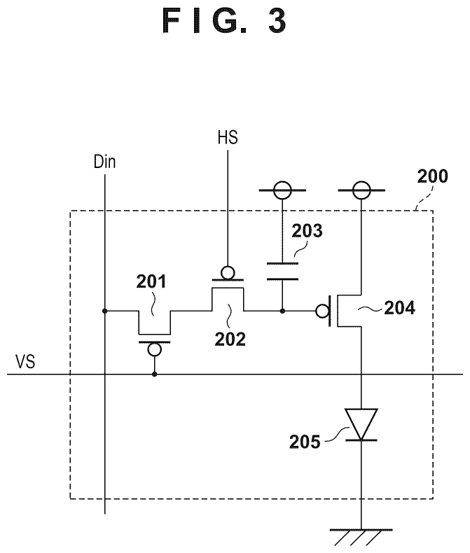

The light emitting device 100 is a device that displays a desired image or the like on a pixel region 110 including the plurality of pixels 200. Each of the plurality of pixels 200 includes a light emitting element 205 (shown in FIG. 3), and the plurality of pixels 200 are arranged in the pixel region 110 in rows and columns.

The receiving circuit 101 receives display data supplied from the outside of the light emitting device 100 for display on the pixel region 110. The display data received by the receiving circuit 101 is supplied to the signal processing circuit 102. The memory 103 is connected to the signal processing circuit 102. The memory 103 is a memory area for temporarily storing the display data supplied from the outside.

The signal processing circuit 102 processes the display data for display on the pixel region 110. The signal processing circuit 102 selects, from the plurality of pixels 200, pixels of a group 151 and pixels of a group 152, signal values each corresponding to the luminous brightness of the pixels in the group 151 exceeding a predetermined threshold, and signal values of the pixels in the group 152 being equal to or smaller than the predetermined threshold out of the plurality of pixels 200. For example, the signal processing circuit 102 selects the pixels 200 of the group 151 and the pixels 200 of the group 152 based on the signal value of each pixel 200 included in the display data held by the memory 103. The signal processing circuit 102 supplies, to the driving circuit 111, the driving data of the pixels 200 respectively selected to the groups 151 and 152.

As the driving data, the signal processing circuit 102 transfers column driving data to the column selection circuit 104, and signal value data to the column memory 105. Each of the column driving data and the signal value data can be data for each pixel row in the pixel region 110 including the plurality of pixels 200. The signal processing circuit 102 also transmits a timing control signal for controlling the operation timing in the driving circuit 111 to the timing signal generator 106.

The column selection circuit 104 supplied with the column driving data generates a signal for selecting the pixel 200 in a predetermined column for each pixel row. The column selection circuit 104 also causes the column memory 105 to supply, to the column DAC 107, the data (to be sometimes referred to as column data hereinafter) of the signal value corresponding to each pixel 200 in the selected column among the signal value data supplied to the column memory 105. Here, a description is given assuming that some data are selected from the signal value data supplied to the column memory 105 and supplied to the column DAC 107. However, all the signal value data supplied to the column memory 105 may be supplied to the column DAC 107 for each pixel row.

In accordance with a timing signal input from the timing signal generator 106, the column DAC 107 DA-converts the column data signal supplied from the column memory 105. The column data signal converted from a digital value to an analog value by the column DAC 107 is supplied to the pixel region 110 via the column buffer 108. At this time, the timing signal generator 106 supplies a timing signal to the row selection circuit 109, which allows the row selection circuit 109 to generate a row selection signal in synchronization with the column data. Selection of the row of the plurality of pixels 200 arranged in a matrix is executed as needed. By sequentially selecting the rows and columns, a signal having the signal value corresponding to the luminous brightness is written in the pixel 200.

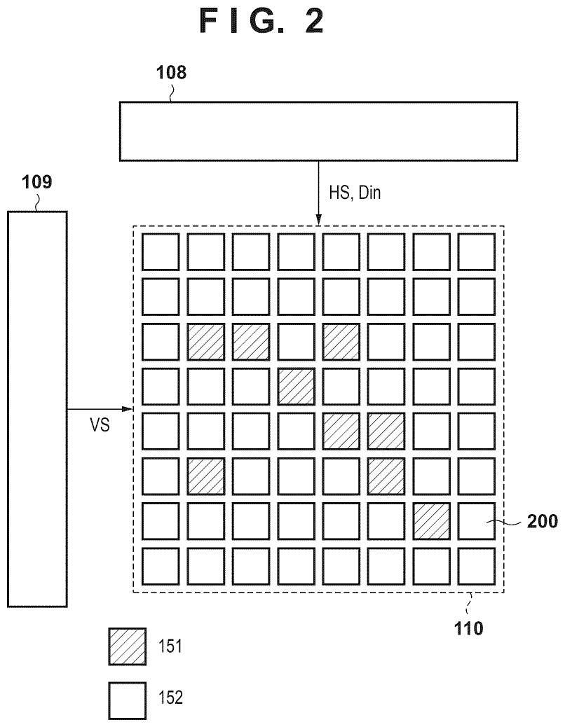

FIG. 2 shows an example of display data. The plurality of pixels 200 are arranged in n rows (n is an integer of 2 or more)×m columns (m is an integer of 2 or more) in the pixel region 110. FIG. 2 shows a state in which the pixels 200 are grouped based on the display data in one frame period for displaying one image. As described above, the signal processing circuit 102 groups the pixels 200 based on whether the signal value of the pixel 200 exceeds the threshold. In FIG. 2, the hatched pixel 200 is the pixel of the group 151 constituted by pixels whose signal values exceed the predetermined threshold, and the white pixel 200 is the pixel of the group 152 constituted by pixels whose signal values are equal to or smaller than the predetermined threshold. Each pixel 200 is driven in accordance with a signal HS(m) and a signal Din(m) supplied from the column selection circuit 104 and the column memory 105 via the column DAC 107 and the column buffer 108, and a signal VS(n) supplied from the row selection circuit 109. The signal HS(m) is a signal generated by the column selection circuit 104 for selecting the column to write a signal. The signal Din(m) is signal value data (signal value) supplied from the column memory 105 via the column DAC 107 and the column buffer 108. The signal VS(n) is a signal supplied from the row selection circuit 109 for selecting the row to write a signal. Here, m and n are integers of 2 or more as described above, and an example will be described below in which m=8 and n=8.

FIG. 3 is a circuit diagram showing an example of the arrangement of the pixel 200 arranged in the pixel region 110. The pixel 200 includes a row selection transistor 201, a column selection transistor 202, a holding capacitor 203 for holding a written signal, a driving transistor 204, and the light emitting element 205. In the arrangement shown in FIG. 3, the row selection transistor 201, the column selection transistor 202, and the driving transistor 204 are shown as p-channel transistors. However, the present invention is not limited to this, and a suitable configuration not limited to the transistors may be used.

The signal VS(n) is supplied to the gate of the row selection transistor 201. The signal HS(m) is supplied to the gate of the column selection transistor 202. One main terminal (the drain in the arrangement shown in FIG. 3) of the row selection transistor 201 is connected to the signal line to which the signal Din(m) is supplied, and the other main terminal (the source in the arrangement shown in FIG. 3) is connected to one main terminal (the drain in the arrangement shown in FIG. 3) of the column selection transistor 202. The other main terminal (the source in the arrangement shown in FIG. 3) of the column selection transistor 202 is connected between one terminal of the holding capacitor 203 and the gate of the driving transistor 204. In the arrangement shown in FIG. 3, the column selection transistor 202 is arranged between the row selection transistor 201 and the driving transistor 204, but the row selection transistor 201 may be arranged between the column selection transistor 202 and the driving transistor 204. The other terminal of the holding capacitor 203 is connected to a predetermined potential line (for example, a VDD line or the like) or a signal line of a predetermined potential such as a GND line.

One electrode (the anode in the arrangement shown in FIG. 3) of the light emitting element 205 is directly or indirectly connected to one main terminal (the source in the arrangement shown in FIG. 3) of the driving transistor 204. Here, the expression “indirectly” means that another element is arranged between the driving transistor 204 and the light emitting element 205. The other main terminal (the drain in the arrangement shown in FIG. 3) of the driving transistor 204 is directly or indirectly connected to the potential line. The other electrode (the cathode in the arrangement shown in FIG. 3) of the light emitting element 205 is connected to the GND line. Here, the driving transistor 204 is described as a p-channel transistor, but may be an n-channel transistor. In that case, the connection relationship concerning the potential line and the GND line can be reversed. When both the row selection transistor 201 and the column selection transistor 202 are selected, the signal of the signal Din(m) is written in the holding capacitor 203, and the gate-source voltage of the driving transistor 204 changes in accordance with the signal value. When a driving current corresponding to the gate-source voltage of the driving transistor 204 flows through the light emitting element 205, the light emitting element 205 emits light with a brightness corresponding to the signal value.

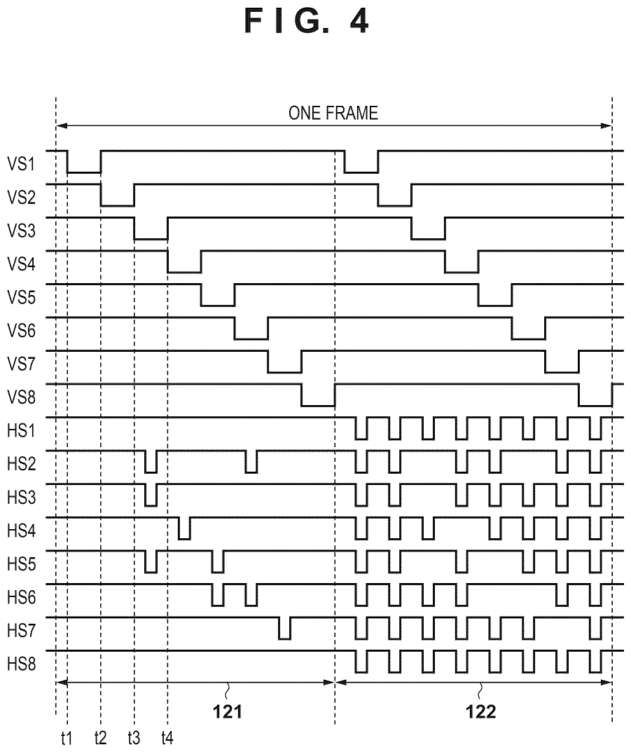

FIG. 4 is a timing chart showing a specific operation example of the light emitting device 100 according to this embodiment. The operation shown in FIG. 4 will be described assuming that, out of the pixels 200 arranged in the pixel region 110, the pixels in the second, third, and fifth columns in the third row, the pixel in the fourth column in the fourth row, the pixels in the fifth and sixth columns in the fifth row, the pixels in the second and sixth columns in the sixth row, and the pixel in the seventh column in the seventh row constitute the pixels of the group 151, and the remaining pixels constitute the pixels of the group 152, as shown in FIG. 2. Here, the example will be described in which n=8 for the signal VS(n) and m=8 for the signal HS(m) as described above, but n and m are only required to be integers of 2 or more. It is also assumed that the abscissa represents time in FIG. 4, and time elapses from left to right. The signal selection with respect to the time elapse is merely an example, and the order of selection does not matter.

When a signal VS(1) is set at low level at time t1, the row selection transistors 201 in the first row are set in the ON (conductive) state and the pixels 200 in the first row are selected until the signal VS(1) is returned at high level at time t2. In the period from time t1 to time t2, all the signals HS(m) are at high level so that the column selection transistors 202 are not set in the ON state, and the new signal is not written in the holding capacitors 203. Similarly, in the period from time t2 to time t3, a signal VS(2) is set at low level and the row selection transistors 201 in the second row are set in the ON (conductive) state. The pixels 200 in the second row are selected but all the signals HS(m) are at high level so no signal is written. This is so because, as shown in FIG. 2, the pixel 200 constituting the group 151 is not arranged in the first and second pixel rows.

Then, a signal VS(3) is set at low level at time t3, and the pixels 200 in the third row are selected until time t4. At this time, signals HS(2), HS(3), and HS(5) are set at low level. Accordingly, the column selection transistors 202 arranged in the second, third, and fifth columns transition to the ON state, and a signal is written in the holding capacitor 203 of each of the pixels 200 in the second, third, and fifth columns in the selected third row. If the signal in the holding capacitor 203 is rewritten, the gate potential of the driving transistor 204 changes so that the amount of current flowing through the light emitting element 205 changes and the brightness of the light emitting element 205 changes. In this manner, the driving circuit 111 (since the column selection circuit 104, the column memory 105, the timing signal generator 106, the column DAC 107, the column buffer 108, and the row selection circuit 109 cooperatively operate, they are sometimes simply referred to as the driving circuit 111) writes signals in the pixels 200 included in the group 151 in a period 121.

One frame period in which a signal for displaying one image based on one display data is written in each pixel 200 includes the above-described period 121 in which the driving circuit 111 writes signals in the pixels 200 included in the group 151, and a period 122 in which the driving circuit 111 writes signals in the pixels 200 included in the group 152. The period 121 and the period 122 are periods different from each other. In the operation example shown in FIG. 4, in the period 121, the driving circuit 111 sequentially selects a pixel 200 included in the group 151 for a pixel row out of the pixels 200 of the group 151 (signal VS(n)), and writes the signal (signal Din(m)) in the pixel 200 arranged in the selected pixel row (signal HS(m)). Then, in the period 122, the driving circuit 111 sequentially selects a pixel 200 included in the group 152 for a pixel row out of the pixels 200 of the group 152 (signal VS(n)), and writes the signal (signal Din(m)) in the pixel 200 arranged in the selected pixel row (signal HS(m)).

As has been described above, the signal processing circuit 102 selects, from the plurality of pixels 200, the pixels 200 constituting the group 151 and the pixels 200 constituting the group 152. After the selection, the signal processing circuit 102 supplies, to the column selection circuit 104, the column driving data indicating the columns where the groups 151 and 152 are respectively arranged to the column selection circuit 104 for each pixel row. The signal processing circuit 102 also transfers the signal value data stored in, for example, the memory 103 to the column memory 105 for each pixel row. The column driving data indicating the columns where the selected pixels 200 respectively included in the groups 151 and 152 may be, for example, temporarily stored in the memory 103. Thereafter, for example, the column driving data may be read out by the signal processing circuit 102 for each pixel row, and supplied to the column selection circuit 104. Thus, the operation shown in FIG. 4 can be implemented. For example, the signal processing circuit 102 supplies, to the column selection circuit 104 and the column memory 105, the column driving data for the pixels 200 constituting the group 151 out of the pixels 200 in the first row and the signal value data for the first row, and repeats a similar operation up to the eighth row (the operation in the period 121). Then, the signal processing circuit 102 supplies, to the column selection circuit 104 and the column memory 105, the column driving data for the pixel 200 constituting the group 152 out of the pixels 200 in the first row and the signal value data for the first row, and may repeat a similar operation up to the eighth row (the operation in the period 122).

In the operation shown in FIG. 4, the period 121 is the period preceding to the period 122 in one frame period. However, the present invention is not limited to this, and the period 121 may be the period succeeding to the period 122 in one frame period.

With the operation shown in FIG. 4, it is possible to write the signal separately in the pixel 200 of the group 151 including the pixels whose signal values exceed the predetermined threshold and exhibit high luminous brightness, and in the pixel 200 of the group 152 including the pixels whose signal values are equal to or smaller than the predetermined threshold. When writing a signal having a signal value exceeding the predetermined threshold in the pixel 200, the potential of the power supply line common to the plurality of pixels 200 may temporarily fluctuate. In addition, when the signal value is rewritten, the pixel 200 may emit light with a high brightness and this may cause a high current to flow, resulting in temporary fluctuation of the potential of the power supply line. The temporary potential fluctuation can be larger when the signal is written in the pixel 200 that emits light with a higher brightness. If a signal having a signal value corresponding to the luminous brightness is written during the fluctuation of the potential of the power supply line, the signal value can fluctuate due to the influence of the fluctuation of the potential of the power supply line, and uneven light emission or the like can occur in the simultaneously selected pixel rows. The uneven light emission can be more easily visually recognized in the pixel 200 that emits light with a low brightness.

Therefore, in this embodiment, as shown in FIG. 4, the signal write period is set for each of the pixel 200 of the group 151 for the signal value exceeding the predetermined threshold and the pixel 200 of the group 152 for the signal value equal to or smaller than the predetermined threshold. With this, it is possible to suppress the influence of temporary fluctuation of the potential of the power supply line, thereby suppressing uneven light emission.

Here, the threshold for grouping the pixels 200 according to the signal value by the signal processing circuit 102 may be one fixed value. Alternatively, for example, the threshold for grouping the pixels 200 according to the signal value by the signal processing circuit 102 may be appropriately adjustable. In that case, the threshold may be adjusted to an appropriate value by the user. Alternatively, for example, the threshold may be changed in accordance with the level of the signal value of the signal of each of the plurality of pixels 200. For example, the signal processing circuit 102 may change the threshold in accordance with the average value, maximum value, minimum value, or frequency distribution of the signal values of the signals of the plurality of pixel 200 included in display data. A setting circuit for setting the threshold may be arranged in the light emitting device 100. For example, the threshold may be set such that the number of the pixels 200 constituting the group 151 becomes equal to or smaller than a predetermined number. For example, the threshold may be set such that the number of the pixels 200 constituting the group 151 becomes equal to or smaller than number of the pixels 200 constituting the group 152. Alternatively, for example, the threshold may be set such that the number of the pixels 200 constituting the group 151 becomes ¾ or less, ⅔ or less, or half or less the number of the pixels 200 constituting the group 152. With this, it is possible to keep the temporary fluctuation of the potential of the power supply line within a predetermined range, thereby suppressing a degradation in quality of the displayed image. The threshold may be adjusted for each frame, or may be adjusted, for example, for every frames corresponding to one moving image.

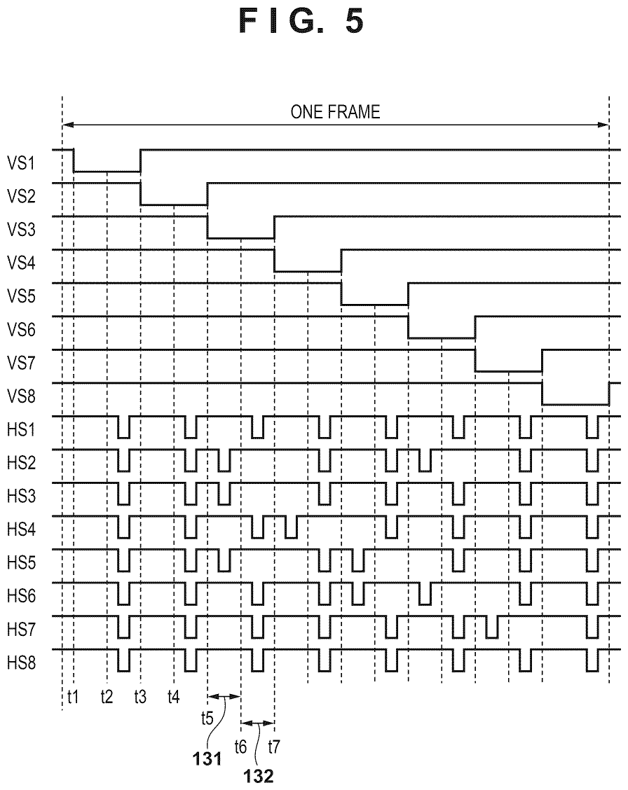

FIG. 5 is a timing chart showing a modification of the operation shown in FIG. 4. Differences from the operation shown in FIG. 4 will be described below. In the operation shown in FIG. 4, the example has been described in which the signal is written in the pixels 200 constituting the group 151 over all the pixel rows, and then the signal is written in the pixels 200 constituting the group 152 over all the pixel rows. On the other hand, in the driving method shown in FIG. 5, the signal is written in the pixels 200 constituting the group 151 and the pixels 200 constituting the group 152 for each pixel row. However, similar to the above example, a period 131 for writing the signal in the pixels 200 constituting the group 151 is different from a period 132 for writing the signal in the pixels 200 constituting the group 152.

When the signal VS(1) is set at low level at time t1, the pixels 200 in the first row are selected until the signal VS(1) is returned to high level at time t3. In the period from time t1 to time t2, all the signals HS(m) are set at high level so the column selection transistors 202 are not set in the ON state, and the new signal is not written in the holding capacitors 203. On the other hand, in the period from time t2 to time t3, the signals HS(1) to HS(8) are set at low level so that the signal is written in the holding capacitor 203 of each pixel 200 constituting the group 152 out of the pixels 200 in the first row. This also applies to the period from time t3 to time t5 when the pixels 200 in the second row are selected.

Then, the signal VS(3) is set at low level at time t5, and the pixels 200 in the third row are selected until time t7. In the period 131 from time t5 to time t6, the signals HS(2), HS(3), and HS(5) are set at low level, and the column selection transistors 202 arranged in the second, third, and fifth columns transition to the ON state. Accordingly, a signal is written in the pixels 200 located in the second, third, and fifth columns in the selected third row and constituting the group 151. Then, in the period 132 from time t6 to time t7, the signals HS(1), HS(4), HS(6), HS(7), and HS(8) are set at low level, and the column selection transistors 202 arranged in the first, fourth, and sixth to eighth columns transition to the ON state. Accordingly, a signal is written in the pixels 200 located in the first, fourth, and sixth to eighth columns in the selected third row and constituting the group 152. Subsequently, similar signal writing is performed in each pixel row selected using the signal VS(n).

In the operation shown in FIG. 5, the driving circuit 111 sequentially selects pixels 200 for each pixel row. For each selected pixel row, the driving circuit 111 performs an operation in the period 131 for writing a signal in the pixels 200 arranged in the selected pixel row out of the pixels 200 of the group 151, and an operation in the period 132 for writing a signal in the pixels 200 arranged in the selected pixel row out of the pixels 200 of the group 152. For example, the signal processing circuit 102 supplies the column driving data for the pixels 200 constituting the group 151 out of the pixels 200 in the first row and the signal value data for the first row to the column selection circuit 104 and the column memory 105. Then, the signal processing circuit 102 supplies the column driving data for the pixels 200 constituting the group 152 out of the pixels 200 in the first row to the column selection circuit 104. At this time, since the signal value data for the first row has been already supplied to the column memory 105, the signal processing circuit 102 need not supply the signal value data for the first row to the column memory 105. That is, in the operation shown in FIG. 5, the signal value data can be written in the column memory 105 for each row selection. By repeating this operation up to the eighth row, the operation shown in FIG. 5 can be implemented.

In the operation shown in FIG. 5, the driving circuit 111 performs the operation in the period 132 after performing the operation in the period 131 for each pixel row. However, the present invention is not limited to this, and the driving circuit 111 may perform the operation in the period 131 after performing the operation in the period 132.

Comparing to the operation shown in FIG. 4 that scans the pixel row twice in one frame period, the operation shown in FIG. 5 can shorten the switching time of the signal VS(n). In addition, since the number of times of writing the signal value data in the column memory 105 is reduced to half, it is also possible to suppress the amount and time of communication between the signal processing circuit 102 and the driving circuit 111 (column memory 105).

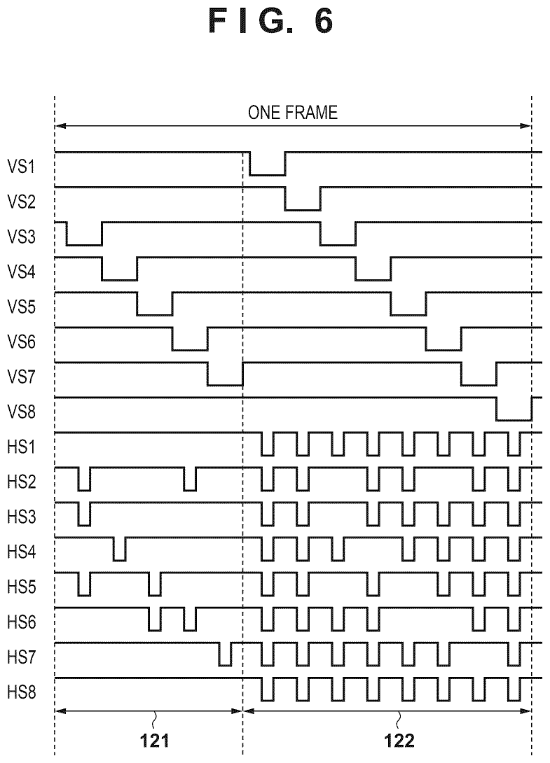

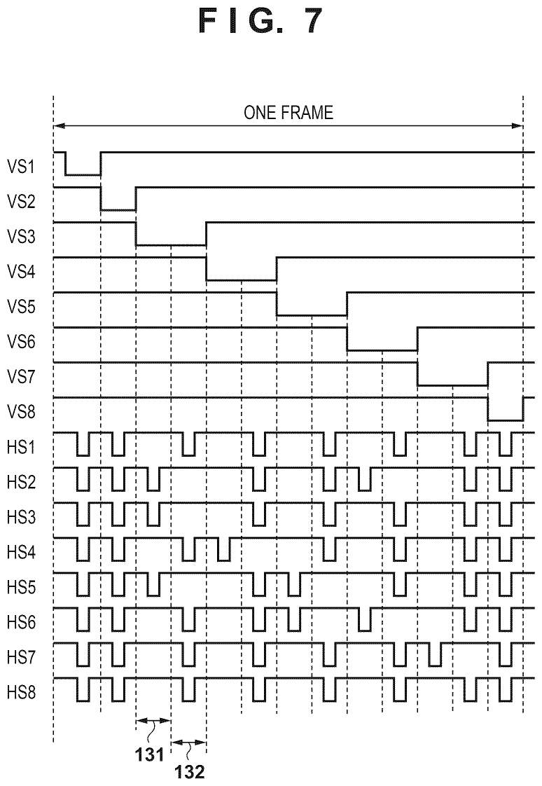

FIG. 6 shows a modification of the operation shown in FIG. 4, and FIG. 7 shows a modification of the operation shown in FIG. 5. In the operations shown in FIGS. 4 and 5, all the pixels 200 are selected once during one frame, and signals are written therein. However, the operation of the light emitting device 100 is not limited to this. As shown in FIG. 6, the driving circuit 111 may not select, in the period 121, the pixel row where the pixel 200 of the group 151 is not arranged. Further, for example, the driving circuit 111 may not select, in the period 122, the pixel row where the pixel 200 of the group 152 is not arranged. Similarly, as shown in FIG. 7, the driving circuit 111 may not perform the operation in the period 131 in the pixel row where the pixel 200 of the group 151 is not arranged. Further, for example, the driving circuit 111 may not perform the operation in the period 132 in the pixel row where the pixel 200 of the group 152 is not arranged. In the operations shown in FIGS. 6 and 7, each pixel row is selected according to the signal VS(n). On the other hand, if a given pixel column is not selected according to the signal HS(m), the signal processing circuit 102 supplies column driving data to the column selection circuit 104 so as to skip the time (period) for selecting the given pixel column. This operation can shorten the operation time in one frame.

It has been described that, in the arrangement shown in FIG. 1, the signal processing circuit 102 is arranged in the light emitting device 100. However, the signal processing circuit 102 is not limited to this, and may be arranged outside the light emitting device 100. In this case, the signal processing circuit 102 generates the above-described driving data and timing control signal based on the display data supplied from the outside of the signal processing circuit 102, and supplies the driving data and timing control signal to the light emitting device including the driving circuit 111 and the pixel region 110 where the plurality of pixels 200 are arranged. This can implement the above-described operation. In this case, the signal processing circuit 102 can also be called a signal processing device or the like. The memory 103 may be incorporated in the signal processing circuit 102, or may be arranged separately from the signal processing circuit 102.

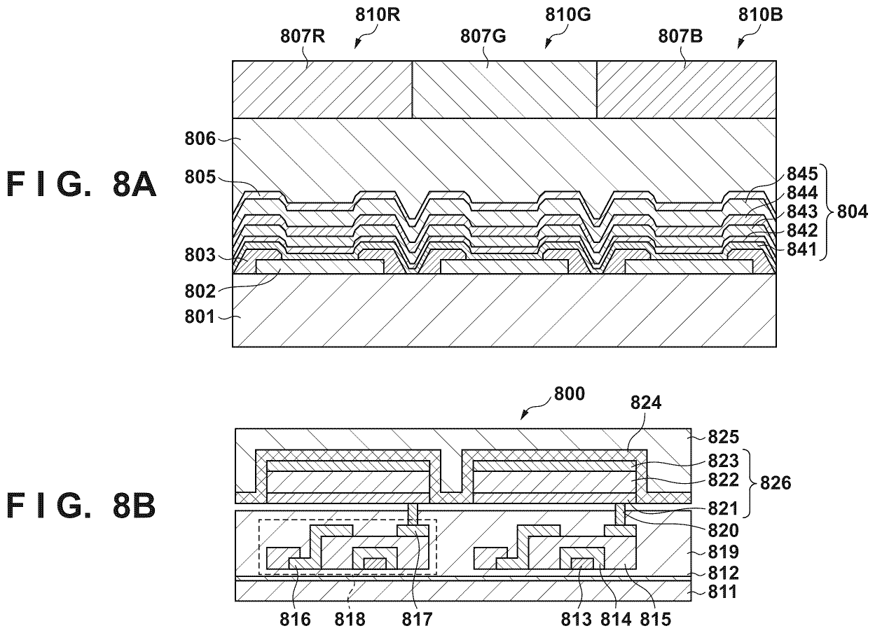

Here, application examples in which the light emitting device 100 according to this embodiment is applied to an image forming device, a display device, a photoelectric conversion device, an electronic apparatus, an illumination device, a moving body, and a wearable device will be described with reference to FIGS. 8A to 16B. The description will be given assuming that, for example, an organic light emitting element such as an organic EL element using an organic light emitting material is arranged in the pixel 200 of the light emitting device 100. Details of each component arranged in the pixel 200 of the light emitting device 100 described above will be described first, and the application examples will be described after that.

The organic light emitting element according to an embodiment of the present disclosure includes a first electrode, a second electrode, and an organic compound layer arranged between these electrodes. One of the first electrode and the second electrode is an anode, and the other is a cathode. In the organic light emitting element according to this embodiment, the organic compound layer may be either a single layer or a stacked body formed by a plurality of layers as long as it includes a light emitting layer. Here, if the organic compound layer is a stacked body formed from a plurality of layers, the organic compound layer may include a hole injection layer, a hole transport layer, an electron blocking layer, a hole/exciton blocking layer, an electron transport layer, an electron injection layer, and the like in addition to the light emitting layer. The light emitting layer may be a single layer or a stacked body formed from a plurality of layers. If the light emitting layer includes a plurality of layers, a charge generation layer may be arranged between the light emitting layers. The charge generation layer may be made of a compound having the LUMO lower than that of the hole transport layer, and the LUMO of the charge generation layer may be lower than the HOMO of the hole transport layer. Here, the molecular orbital energy of the organic compound layer may be the molecular orbital energy of the organic compound with the largest weight ratio in the organic compound layer.

The description is given here assuming that the closer the HOMO and LUMO are to the vacuum level, the “higher” they are. When the LUMO of the charge generation layer is lower than the HOMO of the hole transport layer, the LUMO of the charge generation layer is closer to the vacuum level than the HOMO of the hole transport layer.

The HOMO and LUMO in this specification can be calculated using molecular orbital calculation. The molecular orbital calculation is executed by a Density Functional Theory (DFT) or the like. A functional may be calculated using B3LYP, and a basic function may be calculated using 6-31G*. Note that molecular orbital calculation can be executed using, for example, Gaussian 09 (Gaussian 09, Revision C.01, M. J. Frisch, G. W. Trucks, H. B. Schlegel, G. E. Scuseria, M. A. Robb, J. R. Cheeseman, G. Scalmani, V. Barone, B. Mennucci, G. A. Petersson, H. Nakatsuji, M. Caricato, X. Li, H. P. Hratchian, A. F. Izmaylov, J. Bloino, G. Zheng, J. L. Sonnenberg, M. Hada, M. Ehara, K. Toyota, R. Fukuda, J. Hasegawa, M. Ishida, T. Nakajima, Y. Honda, O. Kitao, H. Nakai, T. Vreven, J. A. Montgomery Jr., J. E. Peralta, F. Ogliaro, M. Bearpark, J. J. Heyd, E. Brothers, K. N. Kudin, V. N. Staroverov, T. Keith, R. Kobayashi, J. Normand, K. Raghavachari, A. Rendell, J. C. Burant, S. S. Iyengar, J. Tomasi, M. Cossi, N. Rega, J. M. Millam, M. Klene, J. E. Knox, J. B. Cross, V. Bakken, C. Adamo, J. Jaramillo, R. Gomperts, R. E. Stratmann, O. Yazyev, A. J. Austin, R. Cammi, C. Pomelli, J. W. Ochterski, R. L. Martin, K. Morokuma, V. G. Zakrzewski, G. A. Voth, P. Salvador, J. J. Dannenberg, S. Dapprich, A. D. Daniels, O. Farkas, J. B. Foresman, J. V. Ortiz, J. Cioslowski, and D. J. Fox, Gaussian, Inc., Wallingford CT, 2010.).

The HOMO and LUMO in this specification can be calculated using the ionization potential and band gap. The HOMO can be estimated by measuring the ionization potential. The ionization potential can be measured by dissolving the compound to be measured in a solvent such as toluene and using a measuring device such as AC-3. The band gap can be measured by dissolving the compound to be measured in a solvent such as toluene and irradiating it with excitation light. The band gap can be measured by measuring the absorption edge of the excitation light. Alternatively, the band gap can be measured by depositing the compound to be measured on a substrate such as glass, and exposing the deposited film to excitation light. The band gap can be measured by measuring the absorption edge of the absorption spectrum at which the deposited film absorbs excitation light.

The LUMO can be calculated using the band gap and ionization potential value. The LUMO can be estimated by subtracting the ionization potential value from the band gap.

The LUMO can also be estimated from the reduction potential. For example, the one-electron reduction potential is estimated using cyclic voltammetry (CV) measurement. The CV measurement can be performed, for example, in a DMF solution of 0.1 M tetrabutylammonium perchlorate using a reference electrode of Ag/Ag+, a counter electrode of Pt, and a working electrode of glassy carbon. The LUMO can be estimated by adding −4.8 eV to the difference between the reduction potential of the obtained compound and that of ferrocene.

In the organic light emitting element according to an embodiment of the present disclosure, if an organic compound according to this embodiment is contained in the light emitting layer, the light emitting layer may be a layer made of only the organic compound according to this embodiment, or may be a layer made of the organic metal complex according to this embodiment and another compound.

### Arrangement of Organic Light Emitting Element

The organic light emitting element is provided by forming an insulating layer, a first electrode, an organic compound layer, and a second electrode on a substrate. A protection layer, a color filter, a microlens, and the like may be provided on a cathode. If a color filter is provided, a planarizing layer may be provided between the protection layer and the color filter. The planarizing layer can be formed using acrylic resin or the like. The same applies to a case where a planarizing layer is provided between the color filter and the microlens.

### Substrate

Quartz, glass, a silicon wafer, a resin, a metal, or the like may be used as a substrate. Furthermore, a switching element such as a transistor, a wiring pattern, and the like may be provided on the substrate, and an insulating layer may be provided thereon. The insulating layer may be made of any material as long as a contact hole can be formed so that the wiring pattern can be formed between the first electrode and the substrate and insulation from the unconnected wiring pattern can be ensured. For example, a resin such as polyimide, silicon oxide, silicon nitride, or the like may be used for the insulating layer.

### Electrode

A pair of electrodes can be used as the electrodes. The pair of electrodes can be an anode and a cathode. If an electric field is applied in the direction in which the organic light emitting element emits light, the electrode having a high potential is the anode, and the other is the cathode. It can also be said that the electrode that supplies holes to the light emitting layer is the anode and the electrode that supplies electrons is the cathode.

As the constituent material of the anode, a material having a large work function may be selected. For example, a metal such as gold, platinum, silver, copper, nickel, palladium, cobalt, selenium, vanadium, or tungsten, a mixture containing some of them, an alloy obtained by combining some of them, or a metal oxide such as tin oxide, zinc oxide, indium oxide, indium tin oxide (ITO), or zinc indium oxide can be used. Furthermore, a conductive polymer such as polyaniline, polypyrrole, or polythiophene can also be used as the constituent material of the anode.

One of these electrode materials may be used singly, or two or more of them may be used in combination. The anode may be formed by a single layer or a plurality of layers.

If the electrode is used as a reflective electrode, for example, chromium, aluminum, silver, titanium, tungsten, molybdenum, an alloy thereof, a stacked layer thereof, or the like can be used. The above materials can function as a reflective film having no role as an electrode. If a transparent electrode is used as the electrode, an oxide transparent conductive layer made of indium tin oxide (ITO), indium zinc oxide, or the like can be used, but the present invention is not limited thereto. A photolithography technique can be used to form the electrode.

On the other hand, as the constituent material of the cathode, a material having a small work function may be selected. Examples of the material include an alkali metal such as lithium, an alkaline earth metal such as calcium, a metal such as aluminum, titanium, manganese, silver, lead, or chromium, and a mixture containing some of them. Alternatively, an alloy obtained by combining these metals can also be used. For example, a magnesium-silver alloy, an aluminum-lithium alloy, an aluminum-magnesium alloy, a silver-copper alloy, a zinc-silver alloy, or the like can be used. A metal oxide such as indium tin oxide (ITO) can also be used. One of these electrode materials may be used singly, or two or more of them may be used in combination. The cathode may have a single-layer structure or a multilayer structure. Silver may be used as the cathode. To suppress aggregation of silver, a silver alloy may be used. The ratio of the alloy is not limited as long as aggregation of silver can be suppressed. For example, the ratio between silver and another metal may be 1:1, 3:1, or the like.

The cathode may be a top emission element using an oxide conductive layer made of ITO or the like, or may be a bottom emission element using a reflective electrode made of aluminum (Al) or the like, and is not particularly limited. The method of forming the cathode is not particularly limited, but if direct current sputtering or alternating current sputtering is used, the good coverage is achieved for the film to be formed, and the resistance of the cathode can be lowered.

### Pixel Isolation Layer

A pixel isolation layer may be formed by a so-called silicon oxide, such as silicon nitride (SiN), silicon oxynitride (SiON), or silicon oxide (SiO), formed using a Chemical Vapor Deposition (CVD) method. To increase the resistance in the in-plane direction of the organic compound layer, the organic compound layer, especially the hole transport layer may be thinly deposited on the side wall of the pixel isolation layer. More specifically, the organic compound layer can be deposited so as to have a thin film thickness on the side wall by increasing the taper angle of the side wall of the pixel isolation layer or the film thickness of the pixel isolation layer to increase vignetting during vapor deposition.

On the other hand, the taper angle of the side wall of the pixel isolation layer or the film thickness of the pixel isolation layer can be adjusted to the extent that no space is formed in the protection layer formed on the pixel isolation layer. Since no space is formed in the protection layer, it is possible to reduce generation of defects in the protection layer. Since generation of defects in the protection layer is reduced, a decrease in reliability caused by generation of a dark spot or occurrence of a conductive failure of the second electrode can be reduced. According to this embodiment, even if the taper angle of the side wall of the pixel isolation layer is not acute, it is possible to effectively suppress leakage of charges to an adjacent pixel. As a result of this consideration, it has been found that the taper angle of 60° (inclusive) to 90° (inclusive) can sufficiently reduce the occurrence of defects. The film thickness of the pixel isolation layer may be 10 nm (inclusive) to 150 nm (inclusive). A similar effect can be obtained in an arrangement including only pixel electrodes without the pixel isolation layer. However, in this case, the film thickness of the pixel electrode is set to be equal to or smaller than half the film thickness of the organic layer or the end portion of the pixel electrode is formed to have a forward tapered shape of less than 60°. With this, short circuit of the organic light emitting element can be reduced.

Furthermore, in a case where the first electrode is the cathode and the second electrode is the anode, a high color gamut and low-voltage driving can be achieved by forming the electron transport material and charge transport layer and forming the light emitting layer on the charge transport layer.

### Organic Compound Layer

The organic compound layer may be formed by a single layer or a plurality of layers. If the organic compound layer includes a plurality of layers, the layers can be called a hole injection layer, a hole transport layer, an electron blocking layer, a light emitting layer, a hole blocking layer, an electron transport layer, and an electron injection layer in accordance with the functions of the layers. The organic compound layer is mainly formed from an organic compound but may contain inorganic atoms and an inorganic compound. For example, the organic compound layer may contain copper, lithium, magnesium, aluminum, iridium, platinum, molybdenum, zinc, or the like. The organic compound layer may be arranged between the first and second electrodes, and may be arranged in contact with the first and second electrodes. If a plurality of light emitting layers are provided, a charge generation portion may be arranged between the first light emitting layer and the second light emitting layer. The charge generation portion may contain an organic compound with a lowest unoccupied molecular orbital energy (LUMO) of −5.0 eV or less. The same applies to a case where a charge generating portion is provided between the second light emitting layer and the third light emitting layer.

### Protection Layer

A protection layer may be provided on the cathode. For example, by adhering glass provided with a moisture absorbing agent on the cathode, permeation of water or the like into the organic compound layer can be suppressed and occurrence of display defects can be suppressed. Furthermore, as another embodiment, a passivation layer made of silicon nitride or the like may be provided on the cathode to suppress permeation of water or the like into the organic compound layer. For example, the protection layer can be formed by forming the cathode, transferring it to another chamber without breaking the vacuum, and forming silicon nitride having a thickness of 2 μm by the CVD method. The protection layer may be provided using an atomic layer deposition (ALD) method after deposition of the protection layer using the CVD method. The material of the protection layer by the ALD method is not limited but can be silicon nitride, silicon oxide, aluminum oxide, or the like. Silicon nitride may further be formed by the CVD method on the protection layer formed by the ALD method. The protection layer formed by the ALD method may have a film thickness smaller than that of the protection layer formed by the CVD method. More specifically, the film thickness of the protection layer formed by the ALD method may be 50% or less, or 10% or less of that of the protection layer formed by the CVD method.

### Color Filter

A color filter may be provided on the protection layer. For example, a color filter considering the size of the organic light emitting element may be provided on another substrate, and the substrate with the color filter formed thereon may be bonded to the substrate with the organic light emitting element provided thereon. Alternatively, for example, a color filter may be patterned on the above-described protection layer using a photolithography technique. The color filter may be formed from a polymeric material.

### Planarizing Layer

A planarizing layer may be arranged between the color filter and the protection layer. The planarizing layer is provided to reduce unevenness of the layer below the planarizing layer. The planarizing layer may be called a material resin layer without limiting the purpose of the layer. The planarizing layer may be formed from an organic compound, and may be made of a low-molecular material or a polymeric material. In consideration of reduction of unevenness, a polymeric organic compound may be used for the planarizing layer.

The planarizing layers may be provided above and below the color filter. In that case, the same or different constituent materials may be used for these planarizing layers. More specifically, examples of the material of the planarizing layer include polyvinyl carbazole resin, polycarbonate resin, polyester resin, ABS resin, acrylic resin, polyimide resin, phenol resin, epoxy resin, silicone resin, and urea resin.

### Microlens

The organic light emitting device may include an optical member such as a microlens on the light emission side. The microlens can be made of acrylic resin, epoxy resin, or the like. The microlens can aim to increase the amount of light extracted from the organic light emitting device and control the direction of light to be extracted. The microlens can have a hemispherical shape. If the microlens has a hemispherical shape, among tangents contacting the hemisphere, there is a tangent parallel to the insulating layer, and the contact between the tangent and the hemisphere is the vertex of the microlens. The vertex of the microlens can be decided in the same manner even in an arbitrary sectional view. That is, among tangents contacting the semicircle of the microlens in a sectional view, there is a tangent parallel to the insulating layer, and the contact between the tangent and the semicircle is the vertex of the microlens.

Furthermore, the middle point of the microlens can also be defined. In the section of the microlens, a line segment from a point at which an arc shape ends to a point at which another arc shape ends is assumed, and the middle point of the line segment can be called the middle point of the microlens. A section for determining the vertex and the middle point may be a section perpendicular to the insulating layer.

The microlens includes a first surface including a convex portion and a second surface opposite to the first surface. The second surface can be arranged on the functional layer (light emitting layer) side of the first surface. For this arrangement, the microlens needs to be formed on the light emitting device. If the functional layer is an organic layer, a process which produces high temperature in the manufacturing step of the microlens may be avoided. In addition, if it is configured to arrange the second surface on the functional layer side of the first surface, all the glass transition temperatures of an organic compound forming the organic layer may be 100° C. or more. For example, 130° C. or more is suitable.

### Counter Substrate

A counter substrate may be arranged on the planarizing layer. The counter substrate is called a counter substrate because it is provided at a position corresponding to the above-described substrate. The constituent material of the counter substrate can be the same as that of the above-described substrate. If the above-described substrate is the first substrate, the counter substrate can be the second substrate.

### Organic Layer

The organic compound layer (hole injection layer, hole transport layer, electron blocking layer, light emitting layer, hole blocking layer, electron transport layer, electron injection layer, and the like) forming the organic light emitting element according to an embodiment of the present disclosure may be formed by the method to be described below.

The organic compound layer forming the organic light emitting element according to the embodiment of the present disclosure can be formed by a dry process using a vacuum deposition method, an ionization deposition method, a sputtering method, a plasma method, or the like. Instead of the dry process, a wet process that forms a layer by dissolving a solute in an appropriate solvent and using a well-known coating method (for example, a spin coating method, a dipping method, a casting method, an LB method, an inkjet method, or the like) can be used.

Here, when the layer is formed by a vacuum deposition method, a solution coating method, or the like, crystallization or the like hardly occurs and excellent temporal stability is obtained. Furthermore, when the layer is formed using a coating method, it is possible to form the film in combination with a suitable binder resin.

Examples of the binder resin include polyvinyl carbazole resin, polycarbonate resin, polyester resin, ABS resin, acrylic resin, polyimide resin, phenol resin, epoxy resin, silicone resin, and urea resin. However, the binder resin is not limited to them.

One of these binder resins may be used singly as a homopolymer or a copolymer, or two or more of them may be used in combination. Furthermore, additives such as a well-known plasticizer, antioxidant, and an ultraviolet absorber may also be used as needed.

### Pixel Circuit

The light emitting device can include a pixel circuit connected to the light emitting element. The pixel circuit may be an active matrix circuit that individually controls light emission of the first and second light emitting elements. The active matrix circuit may be a voltage or current programing circuit. A driving circuit includes a pixel circuit for each pixel. The pixel circuit can include a light emitting element, a transistor for controlling light emission luminance of the light emitting element, a transistor for controlling a light emission timing, a capacitor for holding the gate voltage of the transistor for controlling the light emission luminance, and a transistor for connection to GND without intervention of the light emitting element.

The light emitting device includes a display region and a peripheral region arranged around the display region. The light emitting device includes the pixel circuit in the display region and a display control circuit in the peripheral region. The mobility of the transistor forming the pixel circuit may be smaller than that of a transistor forming the display control circuit.

The slope of the current-voltage characteristic of the transistor forming the pixel circuit may be smaller than that of the current-voltage characteristic of the transistor forming the display control circuit. The slope of the current-voltage characteristic can be measured by a so-called Vg-Ig characteristic.

The transistor forming the pixel circuit is a transistor connected to the light emitting element such as the first light emitting element.

### Pixel

The organic light emitting device includes a plurality of pixels. Each pixel includes sub-pixels that emit light components of different colors. The sub-pixels may include, for example, R, G, and B emission colors, respectively.

In each pixel, a region also called a pixel opening emits light. The pixel opening can have a size of 5 μm (inclusive) to 15 μm (inclusive). More specifically, the pixel opening can have a size of 11 μm, 9.5 μm, 7.4 μm, 6.4 μm, or the like.

A distance between the sub-pixels can be 10 μm or less, and can be, more specifically, 8 μm, 7.4 μm, or 6.4 μm.

The pixels can have a known arrangement form in a plan view. For example, the pixels may have a stripe arrangement, a delta arrangement, a pentile arrangement, or a Bayer arrangement. The shape of each sub-pixel in a plan view may be any known shape. For example, a quadrangle such as a rectangle or a rhombus, a hexagon, or the like may be possible. A shape which is not a correct shape but is close to a rectangle is included in a rectangle, as a matter of course. The shape of the sub-pixel and the pixel arrangement can be used in combination.

### Application of Organic Light Emitting Element of Embodiment of Present Disclosure

The organic light emitting element according to an embodiment of the present disclosure can be used as a constituent member of a display device or an illumination device. In addition, the organic light emitting element is applicable to the exposure light source of an electrophotographic image forming device, the backlight of a liquid crystal display device, a light emitting device including a color filter in a white light source, and the like.

The display device may be an image information processing device that includes an image input unit for inputting image information from an area CCD, a linear CCD, a memory card, or the like, and an information processing unit for processing the input information, and displays the input image on a display unit.

In addition, a display unit included in an image capturing device or an inkjet printer can have a touch panel function. The driving type of the touch panel function may be an infrared type, a capacitance type, a resistive film type, or an electromagnetic induction type, and is not particularly limited. The display device may be used for the display unit of a multifunction printer.

More details will be described next with reference to the accompanying drawings. FIG. 8A shows an example of the pixel 200 arranged in the light emitting device 100. The pixel includes sub-pixels 810 (pixels 200). The sub-pixels are divided into sub-pixels 810R, 810G, and 810B by emitted light components. The light emission colors may be discriminated by the wavelengths of light components emitted from the light emitting layers, or light emitted from each sub-pixel may be selectively transmitted or undergo color conversion by a color filter or the like. Each sub-pixel includes a reflective electrode 802 as the first electrode on an interlayer insulating layer 801, an insulating layer 803 covering the end of the reflective electrode 802, an organic compound layer 804 covering the first electrode and the insulating layer, a transparent electrode 805 as the second electrode, a protection layer 806, and a color filter 807.

The interlayer insulating layer 801 can include a transistor and a capacitive element arranged in the interlayer insulating layer 801 or a layer below it. The transistor and the first electrode can electrically be connected via a contact hole (not shown) or the like.

The insulating layer 803 can also be called a bank or a pixel isolation film. The insulating layer 803 covers the end of the first electrode, and is arranged to surround the first electrode. A portion of the first electrode where no insulating layer 803 is arranged is in contact with the organic compound layer 804 to form a light emitting region.

The organic compound layer 804 includes a hole injection layer 841, a hole transport layer 842, a first light emitting layer 843, a second light emitting layer 844, and an electron transport layer 845.

The second electrode may be a transparent electrode, a reflective electrode, or a semi-transmissive electrode.

The protection layer 806 suppresses permeation of water into the organic compound layer. The protection layer is shown as a single layer but may include a plurality of layers. Each layer can be an inorganic compound layer or an organic compound layer.

The color filter 807 is divided into color filters 807R, 807G, and 807B by colors. The color filters can be formed on a planarizing film (not shown). A resin protection layer (not shown) may be arranged on the color filters. The color filters can be formed on the protection layer 806. Alternatively, the color filters can be provided on the counter substrate such as a glass substrate, and then the substrate may be bonded.

A display device 800 (corresponding to the above-described light emitting device 100) shown in FIG. 8B is provided with an organic light emitting element 826 and a TFT 818 as an example of a transistor. A substrate 811 of glass, silicon, or the like is provided and an insulating layer 812 is provided on the substrate 811. The active element such as the TFT 818 is arranged on the insulating layer, and a gate electrode 813, a gate insulating film 814, and a semiconductor layer 815 of the active element are arranged. The TFT 818 further includes the semiconductor layer 815, a drain electrode 816, and a source electrode 817. An insulating film 819 is provided on the TFT 818. The source electrode 817 and an anode 821 forming the organic light emitting element 826 are connected via a contact hole 820 formed in the insulating film.

A method of electrically connecting the electrodes (anode and cathode) included in the organic light emitting element 826 and the electrodes (source electrode and drain electrode) included in the TFT is not limited to that shown in FIG. 8B. That is, one of the anode and cathode and one of the source electrode and drain electrode of the TFT are electrically connected. The TFT indicates a thin-film transistor.

In the display device 800 shown in FIG. 8B, an organic compound layer is illustrated as one layer. However, an organic compound layer 822 may include a plurality of layers. A first protection layer 824 and a second protection layer 825 are provided on a cathode 823 to suppress deterioration of the organic light emitting element.

A transistor is used as a switching element in the display device 800 shown in FIG. 8B but may be used as another switching element.

The transistor used in the display device 800 shown in FIG. 8B is not limited to a transistor using a single-crystal silicon wafer, and may be a thin-film transistor including an active layer on an insulating surface of a substrate. Examples of the active layer include single-crystal silicon, amorphous silicon, non-single-crystal silicon such as microcrystalline silicon, and a non-single-crystal oxide semiconductor such as indium zinc oxide and indium gallium zinc oxide. Note that a thin-film transistor is also called a TFT element.

The transistor included in the display device 800 shown in FIG. 8B may be formed in the substrate such as a silicon substrate. Forming the transistor in the substrate means forming the transistor by processing the substrate such as a silicon substrate. That is, when the transistor is included in the substrate, it can be considered that the substrate and the transistor are formed integrally.

The light emission luminance of the organic light emitting element according to this embodiment can be controlled by the TFT which is an example of a switching element, and the plurality of organic light emitting elements can be provided in a plane to display an image with the light emission luminances of the respective elements. Here, the switching element according to this embodiment is not limited to the TFT, and may be a transistor formed from low-temperature polysilicon or an active matrix driver formed on the substrate such as a silicon substrate. The term “on the substrate” may mean “in the substrate”. Whether to provide a transistor in the substrate or use a TFT is selected based on the size of the display unit. For example, if the size is about 0.5 inch, the organic light emitting element may be provided on the silicon substrate.

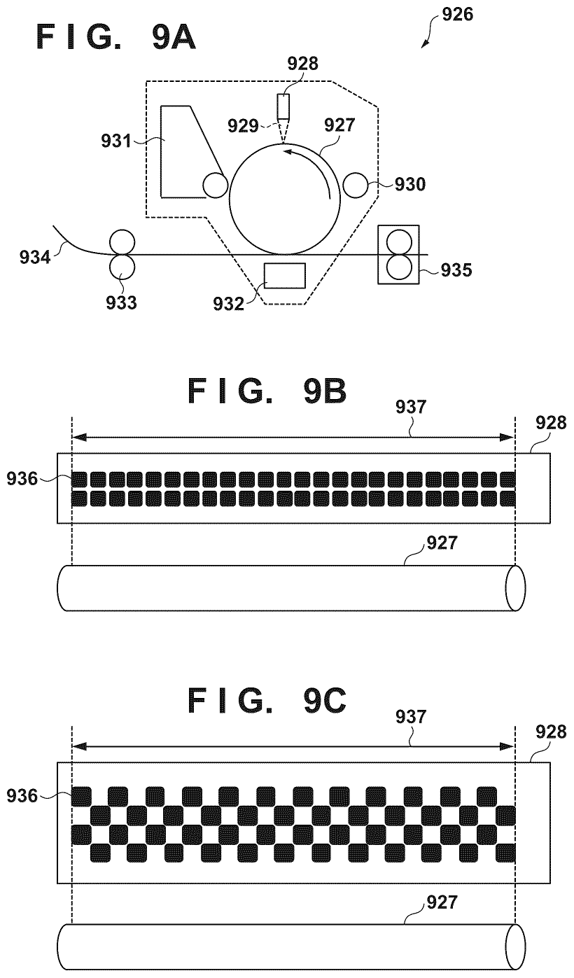

FIGS. 9A to 9C are schematic views showing an example of an image forming device using the light emitting device 100 according to this embodiment. An image forming device 926 shown in FIG. 9A includes a photosensitive member 927, an exposure light source 928, a developing unit 931, a charging unit 930, a transfer device 932, a conveyance unit 933 (a conveyance roller in the arrangement shown in FIG. 9A), and a fixing device 935.

Light 929 is emitted from the exposure light source 928, and an electrostatic latent image is formed on the surface of the photosensitive member 927. The light emitting device 100 can be applied to the exposure light source 928. The developing unit 931 can function as a developing device that includes a toner or the like as a developing agent and applies the developing agent to the exposed photosensitive member 927. The charging unit 930 charges the photosensitive member 927. The transfer device 932 transfers the developed image to a print medium 934. The conveyance unit 933 conveys the print medium 934. The print medium 934 can be, for example, paper, a film, or the like. The fixing device 935 fixes the image formed on the print medium.

Each of FIGS. 9B and 9C is a schematic view showing a form in which a plurality of light emitting units 936 are arranged in the exposure light source 928 along the longitudinal direction of a long substrate. The light emitting device 100 can be applied to each of the light emitting units 936. That is, a plurality of the pixels 200 are arranged along the longitudinal direction of the substrate. A direction 937 is a direction parallel to the axis of the photosensitive member 927. This column direction matches the direction of the axis upon rotating the photosensitive member 927. This direction 937 can also be referred to as the long-axis direction of the photosensitive member 927.

FIG. 9B shows a form in which the light emitting units 936 are arranged along the long-axis direction of the photosensitive member 927. FIG. 9C shows a form, which is a modification of the arrangement of the light emitting units 936 shown in FIG. 9B, in which the light emitting units 936 are arranged in the column direction alternately between the first column and the second column. The light emitting units 936 are arranged at different positions in the row direction between the first column and the second column. In the first column, the plurality of light emitting units 936 are arranged apart from each other. In the second column, the light emitting unit 936 is arranged at the position corresponding to the space between the light emitting units 936 in the first column. Furthermore, in the row direction, the plurality of light emitting units 936 are arranged apart from each other. The arrangement of the light emitting units 936 shown in FIG. 9C can be referred to as, for example, an arrangement in a grid pattern, an arrangement in a staggered pattern, or an arrangement in a checkered pattern.

FIG. 10 is a schematic view showing an example of the display device using the light emitting device 100 according to this embodiment. A display device 1000 can include a touch panel 1003, a display panel 1005, a frame 1006, a circuit board 1007, and a battery 1008 between an upper cover 1001 and a lower cover 1009. Flexible printed circuits (FPCs) 1002 and 1004 are respectively connected to the touch panel 1003 and the display panel 1005. Active elements such as transistors are arranged on the circuit board 1007. The battery 1008 is unnecessary if the display device 1000 is not a portable apparatus. Even when the display device 1000 is a portable apparatus, the battery 1008 need not be provided at this position. The light emitting device 100 can be applied to the display panel 1005. The pixels 200 arranged in the light emitting device 100 functioning as the display panel 1005 operate in a state in which they are connected to the active elements such as transistors arranged on the circuit board 1007.

The display device 1000 shown in FIG. 10 can be used for a display unit of a photoelectric conversion device (also referred to as an image capturing device) including an optical unit having a plurality of lenses, and an image sensor for receiving light having passed through the optical unit and photoelectrically converting the light into an electric signal. The photoelectric conversion device can include a display unit for displaying information acquired by the image sensor. In addition, the display unit can be either a display unit exposed outside the photoelectric conversion device, or a display unit arranged in the finder. The photoelectric conversion device can be a digital camera or a digital video camera.

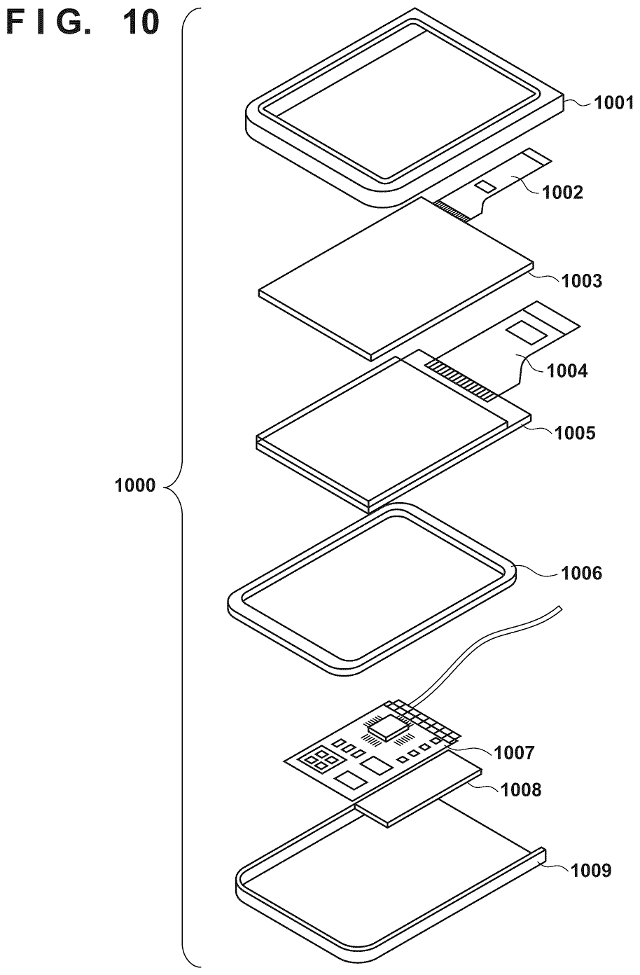

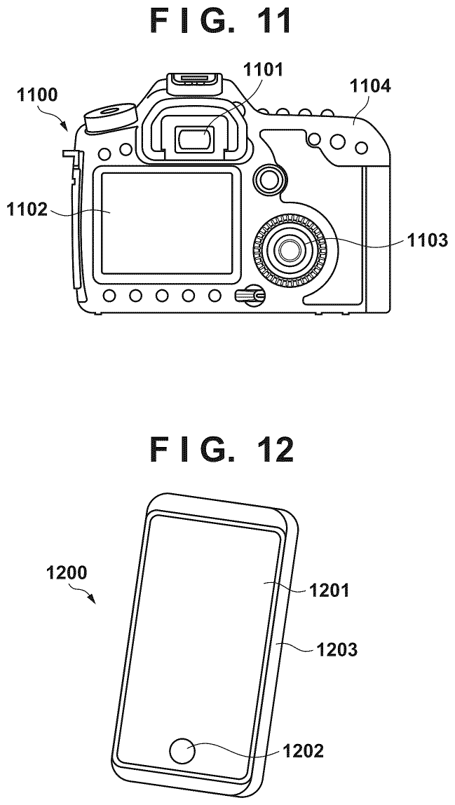

FIG. 11 is a schematic view showing an example of the photoelectric conversion device using the light emitting device 100 according to this embodiment. A photoelectric conversion device 1100 can include a viewfinder 1101, a rear display 1102, an operation unit 1103, and a housing 1104. The photoelectric conversion device 1100 can also be called an image capturing device. The light emitting device 100 according to this embodiment can be applied to the viewfinder 1101 or the rear display 1102 as a display unit. In this case, the light emitting device 100 can display not only an image to be captured but also environment information, image capturing instructions, and the like. Examples of the environment information are the intensity and direction of external light, the moving velocity of an object, and the possibility that an object is covered with an obstacle.

Since the timing suitable for image capturing is a very short time in many cases, it is better to display the information as soon as possible. Therefore, the light emitting device 100 in which the pixel 200 including the light emitting element using the organic light emitting material such as an organic EL element is arranged may be used for the viewfinder 1101 or the rear display 1102. This is so because the organic light emitting material has a high response speed. The light emitting device 100 using the organic light emitting material can be used for the devices that require a high display speed more suitably than for the liquid crystal display device.

The photoelectric conversion device 1100 includes an optical unit (not shown). This optical unit has a plurality of lenses, and forms an image on a photoelectric conversion element (not shown) that receives light having passed through the optical unit and is accommodated in the housing 1104. The focal points of the plurality of lenses can be adjusted by adjusting the relative positions. This operation can also automatically be performed.

The light emitting device 100 may be applied to a display unit of an electronic apparatus. At this time, the display unit can have both a display function and an operation function. Examples of the portable terminal are a portable phone such as a smartphone, a tablet, and a head mounted display.

FIG. 12 is a schematic view showing an example of an electronic apparatus using the light emitting device 100 according to this embodiment. An electronic apparatus 1200 includes a display unit 1201, an operation unit 1202, and a housing 1203. The housing 1203 can accommodate a circuit, a printed board having this circuit, a battery, and a communication unit. The operation unit 1202 can be a button or a touch-panel-type reaction unit. The operation unit 1202 can also be a biometric authentication unit that performs unlocking or the like by authenticating the fingerprint. The portable apparatus including the communication unit can also be regarded as a communication apparatus. The light emitting device 100 according to this embodiment can be applied to the display unit 1201.

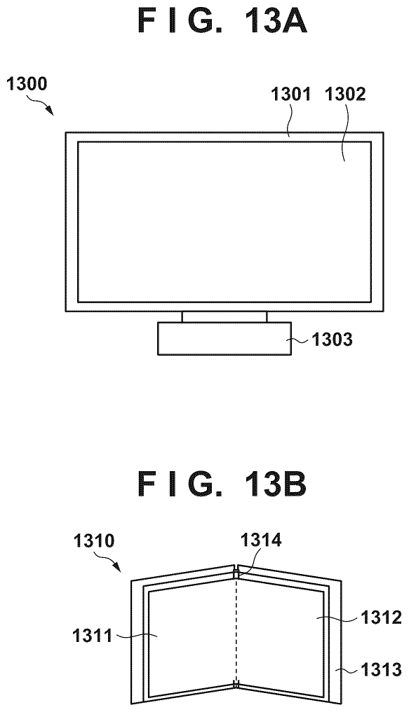

FIGS. 13A and 13B are schematic views showing examples of the display device using the light emitting device 100 according to this embodiment. FIG. 13A shows a display device such as a television monitor or a PC monitor. A display device 1300 includes a frame 1301 and a display unit 1302. The light emitting device 100 according to this embodiment can be applied to the display unit 1302. The display device 1300 can include a base 1303 that supports the frame 1301 and the display unit 1302. The base 1303 is not limited to the form shown in FIG. 13A. For example, the lower side of the frame 1301 may also function as the base 1303. In addition, the frame 1301 and the display unit 1302 can be bent. The radius of curvature in this case can be 5,000 mm (inclusive) to 6,000 mm (inclusive).

FIG. 13B is a schematic view showing another example of the display device using the light emitting device 100 according to this embodiment. A display device 1310 shown in FIG. 13B can be folded, and is a so-called foldable display device. The display device 1310 includes a first display unit 1311, a second display unit 1312, a housing 1313, and a bending point 1314. The light emitting device 100 according to this embodiment can be applied to each of the first display unit 1311 and the second display unit 1312. The first display unit 1311 and the second display unit 1312 can also be one seamless display device. The first display unit 1311 and the second display unit 1312 can be divided by the bending point. The first display unit 1311 and the second display unit 1312 can display different images, and can also display one image together.

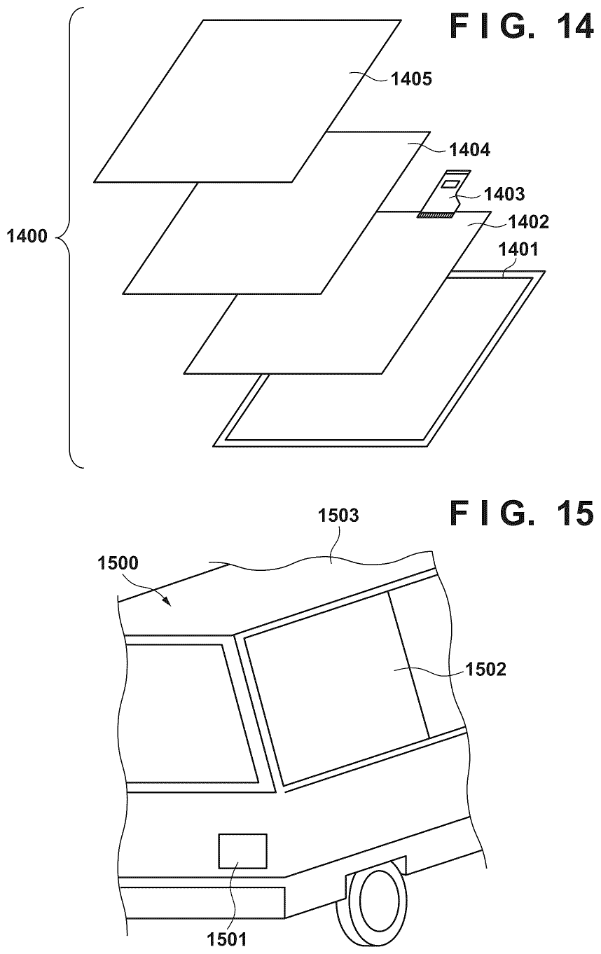

FIG. 14 is a schematic view showing an example of the illumination device using the light emitting device 100 according to this embodiment. An illumination device 1400 can include a housing 1401, a light source 1402, a circuit board 1403, an optical film 1404, and a light diffusing unit 1405. The light emitting device 100 according to this embodiment can be applied to the light source 1402. The optical film 1404 can be a filter that improves the color rendering of the light source. When performing lighting-up or the like, the light diffusing unit 1405 can throw the light of the light source over a broad range by effectively diffusing the light. The illumination device can also include a cover on the outermost portion, as needed. The illumination device 1400 can include both or one of the optical film 1404 and the light diffusing unit 1405.

The illumination device 1400 is, for example, a device for illuminating the interior of the room. The illumination device 1400 can emit white light, natural white light, or light of any color from blue to red. The illumination device 1400 can also include a light control circuit for controlling these light components. The illumination device 1400 can also include a power supply circuit connected to the light emitting device 100 functioning as the light source 1402. The power supply circuit is a circuit for converting an AC voltage into a DC voltage. White has a color temperature of 4,200 K, and natural white has a color temperature of 5,000 K. The illumination device 1400 may also include a color filter. In addition, the illumination device 1400 can include a heat radiation unit. The heat radiation unit radiates the internal heat of the device to the outside of the device, and examples are a metal having a high specific heat and liquid silicon.

FIG. 15 is a schematic view of an automobile having a taillight as an example of a vehicle lighting appliance using the light emitting device 100 according to this embodiment. An automobile 1500 has a taillight 1501, and can have a form in which the taillight 1501 is turned on when performing a braking operation or the like. The light emitting device 100 according to this embodiment can be used as a headlight serving as a vehicle lighting appliance. The automobile is an example of a moving body, and the moving body may be a ship, a drone, an aircraft, a railroad car, an industrial robot, or the like. The moving body may include a main body and a lighting appliance provided in the main body. The lighting appliance may be used to make a notification of the current position of the main body.

The light emitting device 100 according to this embodiment can be applied to the taillight 1501. The taillight 1501 can include a protection member for protecting the light emitting device 100 functioning as the taillight 1501. The material of the protection member is not limited as long as the material is a transparent material with a strength that is high to some extent, and an example is polycarbonate. The protection member may be made of a material obtained by mixing a furandicarboxylic acid derivative, an acrylonitrile derivative, or the like in polycarbonate.

The automobile 1500 can include a vehicle body 1503, and a window 1502 attached to the vehicle body 1503. This window can be a window for checking the front and back of the automobile, and can also be a transparent display such as a head-up display. For this transparent display, the light emitting device 100 according to this embodiment may be used. In this case, the constituent materials of the electrodes and the like of the light emitting device 100 are formed by transparent members.

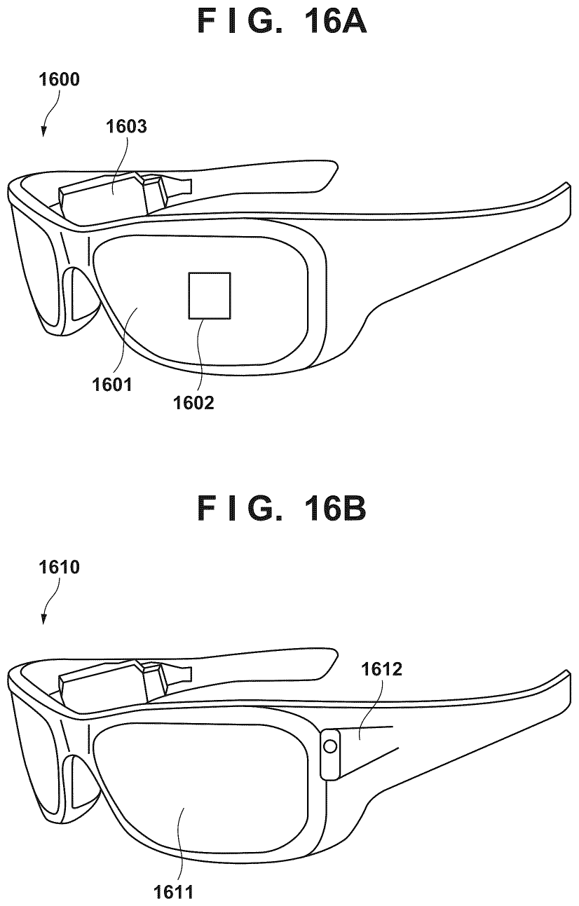

Further application examples of the light emitting device 100 according to this embodiment will be described with reference to FIGS. 16A and 16B. The light emitting device 100 can be applied to a system that can be worn as a wearable device such as smartglasses, a Head Mounted Display (HMD), or a smart contact lens. An image capturing display device used for such application examples includes an image capturing device capable of photoelectrically converting visible light and a light emitting device capable of emitting visible light.

Glasses 1600 (smartglasses) according to one application example will be described with reference to FIG. 16A. An image capturing device 1602 such as a CMOS sensor or an SPAD is provided on the surface side of a lens 1601 of the glasses 1600. In addition, the light emitting device 100 according to this embodiment is provided on the back surface side of the lens 1601.

The glasses 1600 further include a control device 1603. The control device 1603 functions as a power supply that supplies electric power to the image capturing device 1602 and the light emitting device 100 according to each embodiment. In addition, the control device 1603 controls the operations of the image capturing device 1602 and the light emitting device 100. An optical system configured to condense light to the image capturing device 1602 is formed on the lens 1601.

Glasses 1610 (smartglasses) according to one application example will be described with reference to FIG. 16B. The glasses 1610 include a control device 1612, and an image capturing device corresponding to the image capturing device 1602 and the light emitting device 100 are mounted on the control device 1612. The image capturing device in the control device 1612 and an optical system configured to project light emitted from the light emitting device 100 are formed in a lens 1611, and an image is projected to the lens 1611. The control device 1612 functions as a power supply that supplies electric power to the image capturing device and the light emitting device 100, and controls the operations of the image capturing device and the light emitting device 100. The control device 1612 may include a line-of-sight detection unit that detects the line of sight of a wearer. The detection of a line of sight may be done using infrared rays. An infrared ray emitting unit emits infrared rays to an eyeball of the user who is gazing at a displayed image. An image capturing unit including a light receiving element detects reflected light of the emitted infrared rays from the eyeball, thereby obtaining a captured image of the eyeball. A reduction unit for reducing light from the infrared ray emitting unit to the display unit in a planar view is provided, thereby reducing deterioration of image quality.

The line of sight of the user to the displayed image is detected from the captured image of the eyeball obtained by capturing the infrared rays. An arbitrary known method can be applied to the line-of-sight detection using the captured image of the eyeball. As an example, a line-of-sight detection method based on a Purkinje image obtained by reflection of irradiation light by a cornea can be used.

More specifically, line-of-sight detection processing based on pupil center corneal reflection is performed. Using pupil center corneal reflection, a line-of-sight vector representing the direction (rotation angle) of the eyeball is calculated based on the image of the pupil and the Purkinje image included in the captured image of the eyeball, thereby detecting the line-of-sight of the user.

The light emitting device 100 according to the embodiment of the present disclosure can include an image capturing device including a light receiving element, and control a displayed image based on the line-of-sight information of the user from the image capturing device.

More specifically, the light emitting device 100 decides a first visual field region at which the user is gazing and a second visual field region other than the first visual field region based on the line-of-sight information. The first visual field region and the second visual field region may be decided by the control device of the light emitting device 100, or those decided by an external control device may be received. In the display region of the light emitting device 100, the display resolution of the first visual field region may be controlled to be higher than the display resolution of the second visual field region. That is, the resolution of the second visual field region may be lower than that of the first visual field region.

In addition, the display region includes a first display region and a second display region different from the first display region, and a region of higher priority is decided from the first display region and the second display region based on line-of-sight information. The first display region and the second display region may be decided by the control device of the light emitting device 100, or those decided by an external control device may be received. The resolution of the region of higher priority may be controlled to be higher than the resolution of the region other than the region of higher priority. That is, the resolution of the region of relatively low priority may be low.

Note that AI may be used to decide the first visual field region or the region of higher priority. The AI may be a model configured to estimate the angle of the line of sight and the distance to a target ahead the line of sight from the image of the eyeball using the image of the eyeball and the direction of actual viewing of the eyeball in the image as supervised data. The AI program may be held by the light emitting device 100, the image capturing device, or an external device. If the external device holds the AI program, it is transmitted to the light emitting device 100 via communication.

When performing display control based on line-of-sight detection, smartglasses further including an image capturing device configured to capture the outside can be applied. The smartglasses can display captured outside information in real time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-002792, filed Jan. 11, 2024, which is hereby incorporated by reference herein in its entirety.

What is claimed is:

1. A light emitting device comprising:
a plurality of pixels each including a light emitting element, and arranged in rows and columns;
a driving circuit configured to write signals having signal values corresponding to luminous brightness in the plurality of pixels; and
a signal processing circuit,
wherein
the signal processing circuit is configured to select pixels of a first group and pixels of a second group, signal values of the pixels in the first group exceeding a predetermined threshold out of the plurality of pixels, and signal values of the pixels in the second group being not more than the predetermined threshold out of the plurality of pixels, and
the driving circuit is configured to write signals in the pixels included in the first group in a first period, and write signals in the pixels included in the second group in a second period different from the first period.

2. The device according to claim 1, wherein
the driving circuit is configured to
select, in the first period, a pixel included in the first group for a pixel row out of the pixels of the first group, and writes a signal in the pixel arranged in the selected pixel row, and
select, in the second period, a pixel included in the second group for a pixel row out of the pixels of the second group, and writes a signal in the pixel arranged in the selected pixel row.

3. The device according to claim 2, wherein the first period is a period preceding to the second period.

4. The device according to claim 2, wherein the first period is a period succeeding to the second period.

5. The device according to claim 2, wherein in the first period, the driving circuit is configured not to select a pixel row where the pixel of the first group is not arranged.

6. The device according to claim 1, wherein the driving circuit is configured to select pixels for each pixel row, and
the driving circuit is configured to, for each selected pixel row, perform a first operation in the first period for writing a signal in a pixel arranged in the selected pixel row out of the pixels of the first group, and a second operation in the second period for writing a signal in a pixel arranged in the selected pixel row out of the pixels of the second group.

7. The device according to claim 6, wherein for each pixel row, the driving circuit is configured to perform the second operation after performing the first operation.

8. The device according to claim 6, wherein for each pixel row, the driving circuit is configured to perform the first operation after performing the second operation.

9. The device according to claim 6, wherein the driving circuit is configured not to perform the first operation in a pixel row where the pixel of the first group is not arranged.

10. The device according to claim 1, further comprising a memory configured to hold signals for the plurality of pixels.

11. The device according to claim 10, wherein the signal processing circuit is configured to select pixels of the first group and pixels of the second group based on signal values of the signals held in the memory.

12. The device according to claim 1, wherein the predetermined threshold is changed in accordance with a level of signal values of signals for the plurality of pixels.

13. A display device comprising the light emitting device according to claim 1, and an active element connected to the light emitting device.

14. A photoelectric conversion device comprising an optical unit including a plurality of lenses, an image sensor configured to receive light having passed through the optical unit, and a display unit configured to display an image,
wherein the display unit displays an image captured by the image sensor, and includes the light emitting device according to claim 1.

15. An electronic apparatus comprising a housing provided with a display unit, and a communication unit provided in the housing and configured to perform external communication,
wherein the display unit includes the light emitting device according to claim 1.

16. An illumination device comprising a light source, and at least one of a light diffusing unit and an optical film,
wherein the light source includes the light emitting device according to claim 1.

17. A moving body comprising a main body, and a lighting appliance provided in the main body,
wherein the lighting appliance includes the light emitting device according to claim 1.
